(19) United States
(12) Patent Application Publication
(10) Pub. No.: US 2013/0058110 A1
(43) Pub. Date: Mar. 7, 2013

(54) Lamp Seat Structure

(71) Applicants: Shyh-Ming Chen, New Taipei City (TW); Chia-Hsiang Chen, New Taipei City (TW); Tian-Lin Wu, New Taipei City (TW)

(72) Inventors: Shyh-Ming Chen, New Taipei City (TW); Chia-Hsiang Chen, New Taipei City (TW); Tian-Lin Wu, New Taipei City (TW)

(73) Assignee: SHYH-MING CHEN

(21) Appl. No.: 13/429,446

(22) Filed: Mar. 26, 2012

(30) Foreign Application Priority Data
Sep. 7, 2011 (TW) 100216764

(51) Int. Cl. F21V 21/08

(52) U.S. Cl. 362/396

(57) ABSTRACT

The lamp seat structure includes an annular seat and a frame. The annular seat is composed of a cylinder and a plurality of fins radially disposed on an outer surface of the cylinder, in which each of the fins has an engagement protrusion. The frame is formed with a flange. The frame is assembled with the annular seat by engaging the flange with the engagement protrusion, and the engagement protrusion is deformed by the flange to fasten each other.

### BACKGROUND OF THE INVENTION

1. Technical Field

The invention relates to LED lamps, particularly to lamp seats of LED lamps.

2. Related Art

Heat generated from lamps is unavoidable. Though modern lighting elements, such as LEDs, have been dramatically improved in many aspects, generation of heat still cannot be completely precluded. Thus coolers are necessary for all LED lamps.

A typical cooler for an LED lamp is a fin module. Most LED lamps use a cylindrical seat with a fin module to receive an LED. Usually, the seat is further provided with a frame to be a trim.

However, there is no assembling structure between conventional seats and frames. When assembling, an additional material or process, such as a bonding agent or a roll bonding technique, is needed. Such a material or process not only causes cost increase but also tends to be loose.

### SUMMARY OF THE INVENTION

An object of the invention is to provide a lamp seat structure, which can reduce cost and simplify assembling process.

To accomplish the above object, the lamp seat structure includes an annular seat and a frame. The annular seat is composed of a cylinder and a plurality of fins radially disposed on an outer surface of the cylinder, in which each of the fins has an engagement protrusion. The frame is formed with a flange. The frame is assembled with the annular seat by engaging the flange with the engagement protrusion, and the engagement protrusion is deformed by the flange to fasten each other.

### BRIEF DESCRIPTION OF THE DRAWINGS

FIG. 1 is an exploded view of the invention;

FIG. 2 is another exploded view of the invention;

FIG. 3 is a fragmentarily sectional view of the invention;

FIG. 4 is an enlarged sectional view of the invention;

FIG. 5 is a perspective view of the invention;

FIG. 6 is a cross-sectional view showing the invention is applied in an LED lamp;

FIG. 7 is a sectional view of another embodiment of the invention; and

FIG. 8 is a sectional view of still another embodiment of the invention.

### DETAILED DESCRIPTION OF THE INVENTION

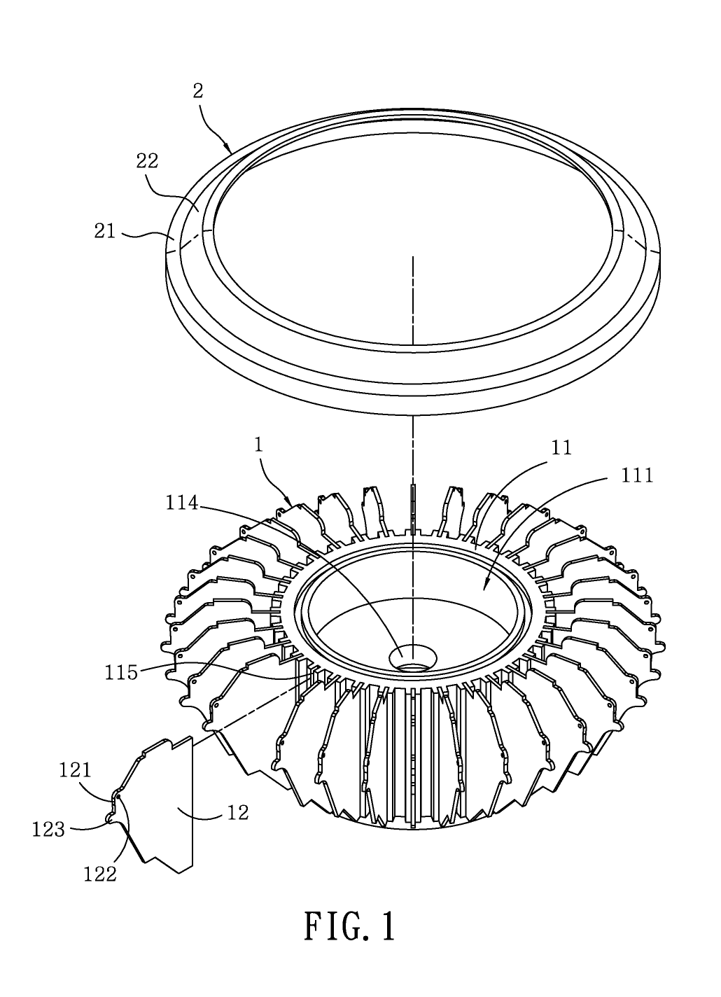

Please refer to FIG. 1. The lamp seat structure includes a seat 1 and a frame 2. The seat 1 further includes a cylinder 11. Two ends of the cylinder 11 are separately provided with a receiving room 111 and an assembling room 112.

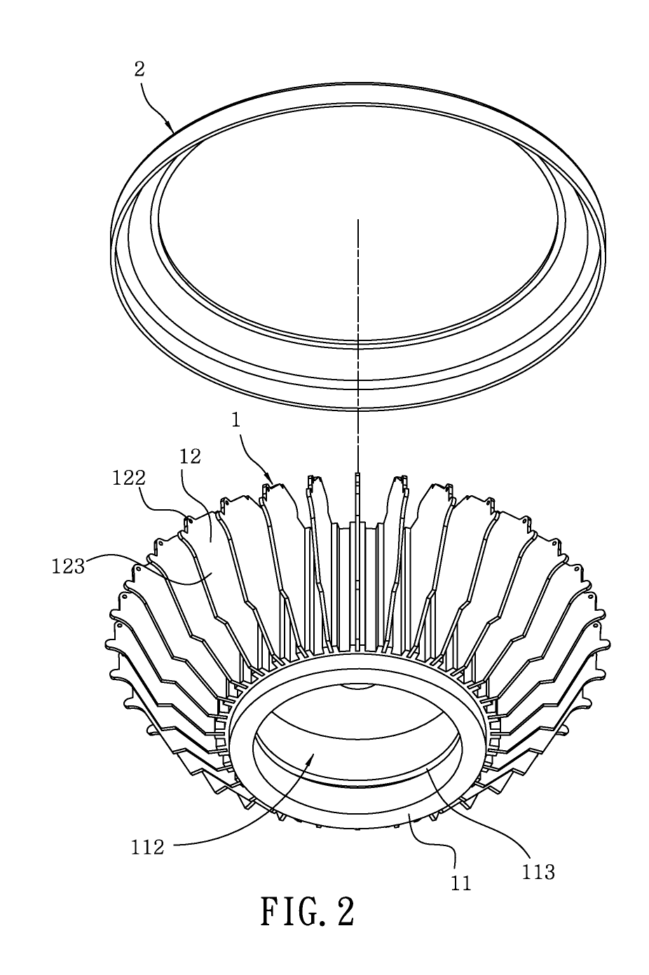

As shown in FIG. 2, the cylinder 11 is formed with a through hole 114 at the axial center thereof, so that the receiving room 111 can communicate with the assembling room 112. An outer surface of the cylinder 11 is formed with a plurality of slots 115. Each of the slots 115 grips a fin 12. Each of the fins 12 is formed with an engagement protrusion 121. There is a passing hole 122 in the engagement protrusion 121. A stopper protrusion 123 is formed near the engagement protrusion 121.

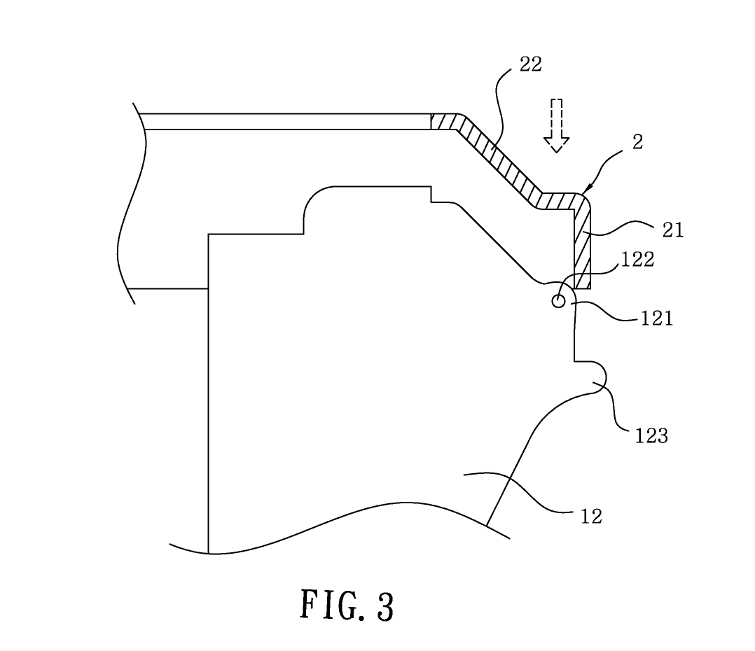

The frame 2 is fastened to the seat 1. The frame 2 is hollow annular body and is formed with a flange 21. As shown in FIG. 3, the flange 21 corresponds to the engagement protrusions 121 of the fins 12. The cross section of the flange 21 is of an L shape. An annular cover 22 upwards extends from the flange 21. The annular cover 22 cloaks edges of the fins 12 to fix them.

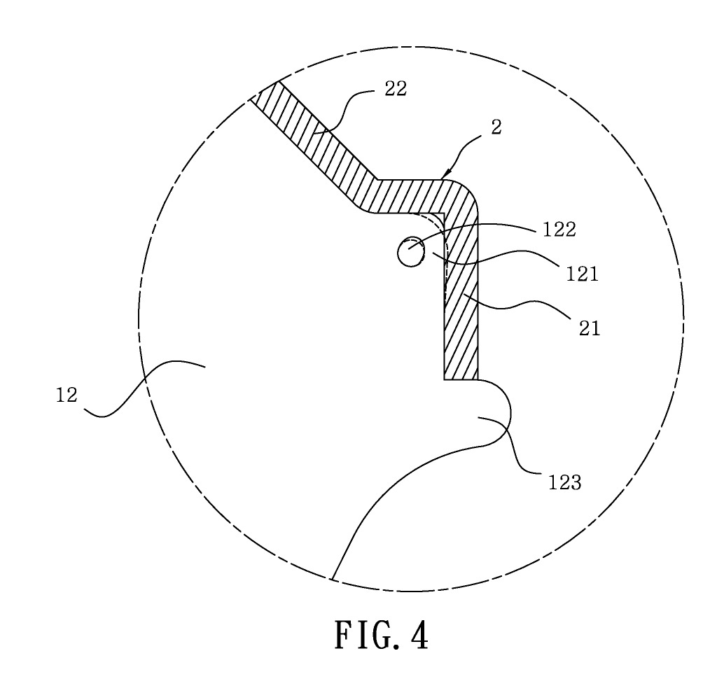

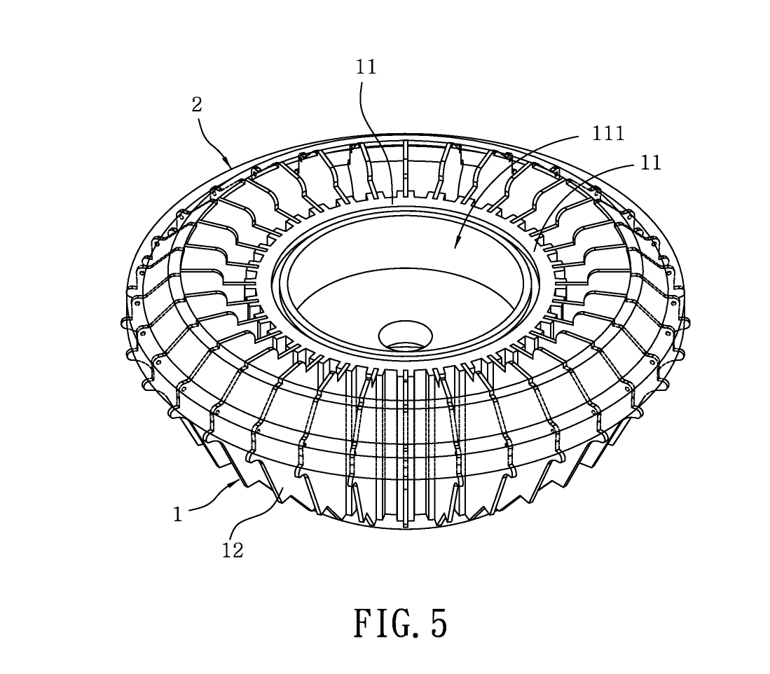

Please refer to FIGS. 3 and 4. When the frame 2 is assembling to the seat 1, the engagement protrusions 121 are pressed by the flange 21 to be deformed. Meanwhile, a part of deformation of the engagement protrusion 121 moves towards the passing hole 122 so that the passing hole 122 is also deformed. The engagement protrusions 121 abut against the flange 21 as shown in FIG. 4. Also, the bottom of the flange 21 abuts against the stopper protrusion 123 and the annular cover 22 abuts against edges of the fins 12. FIG. 5 shows the seat 1 and frame 2 have been assembled.

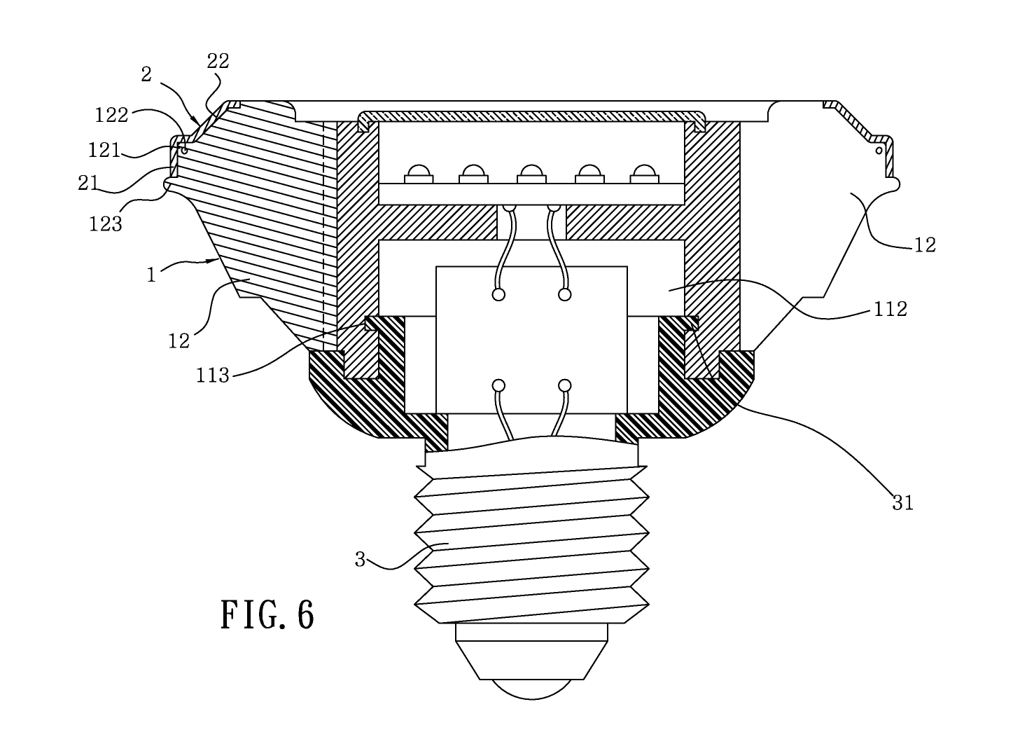

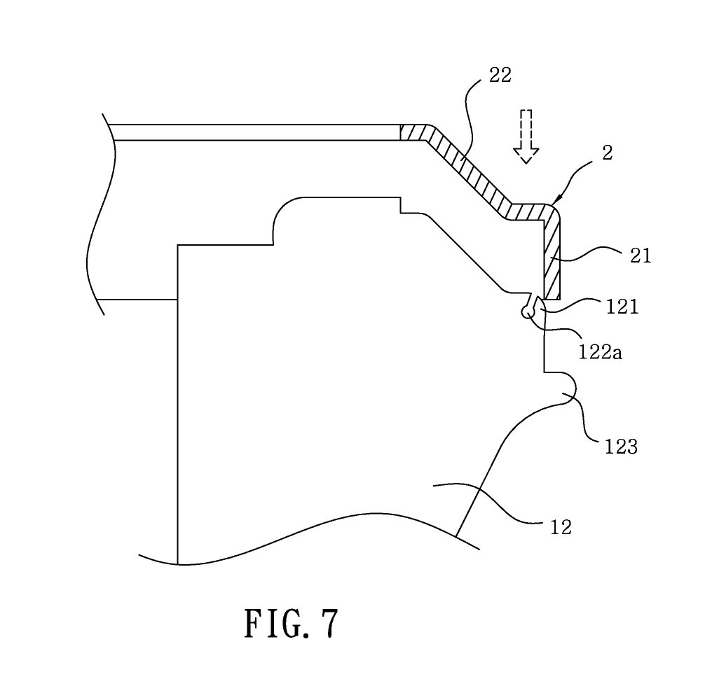

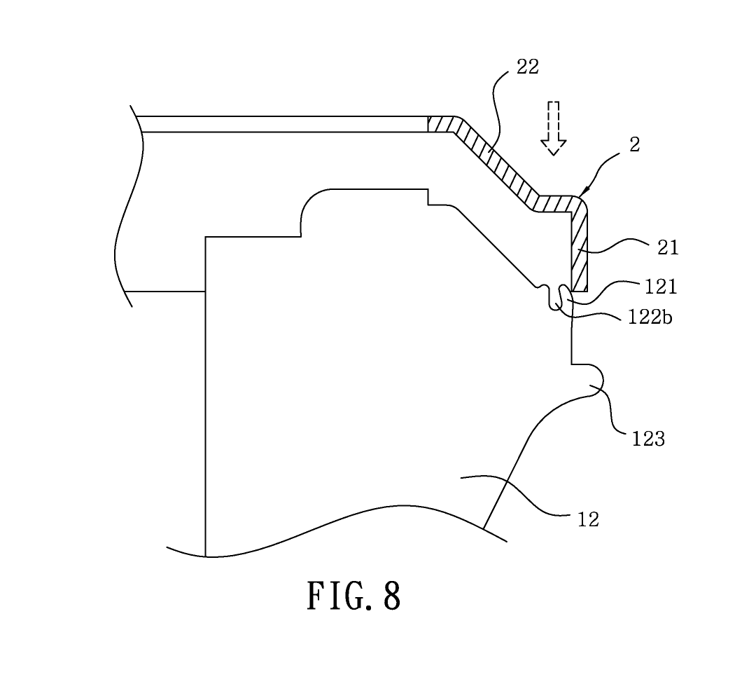

Please refer to FIG. 6. An annular recess 113 is formed in the assembling room 112 for engaging with an insert 31 of the lamp base 3. As a result, the frame 2 can fix the fins 12 to dissipate heat and can provide a trimming and protection effect. Please refer to FIG. 7, which shows another embodiment of the passing hole 122. In this embodiment, an open hole 122a is formed in the engagement protrusion 121. When the frame 2 is assembling to the seat 1, a part of deformation of the engagement protrusion 121 moves towards the open hole 122a so that the fins 12 can be fastened to the flange 21. FIG. 8 shows a dent 122b, which can also function as the passing hole 122 or open hole 122a.

It will be appreciated by persons skilled in the art that the above embodiments have been described by way of example only and not in any limitative sense, and that various alterations and modifications are possible without departure from the scope of the invention as defined by the appended claims.

What is claimed is:

1. A lamp seat structure comprising:
an annular seat comprising:
a cylinder; and
a plurality of fins, radially disposed on an outer surface of the cylinder, each of the fins having an engagement protrusion; and
a frame, having a flange;
wherein the frame is assembled with the annular seat by engaging the flange with the engagement protrusion, and the engagement protrusion is deformed by the flange to fasten each other.

2. The lamp seat structure of claim 1, wherein a stopper protrusion is formed near the engagement protrusion, and a bottom of the flange abuts against the stopper protrusion.

3. The lamp seat structure of claim 1, wherein the cylinder is provided with slots for gripping the fins.

4. The lamp seat structure of claim 1, wherein two ends of the cylinder is formed with a receiving room and an assembling room.

5. The lamp seat structure of claim 4, wherein an inner wall of the assembling room is formed with an annular recess.

6. The lamp seat structure of claim 4, wherein the cylinder is formed with a through hole for making the receiving room communicate with the assembling room.

7. The lamp seat structure of claim 1, wherein the frame is formed with an annular cover extending from the flange and abutting against the fins.

8. The lamp seat structure of claim 1, wherein a cross-section of the flange is of an L shape.

9. The lamp seat structure of claim 1, wherein the engagement protrusion is formed with a passing hole, and deformation of the engagement protrusion moves towards the passing hole so that the passing hole is deformed.

10. The lamp seat structure of claim 1, wherein the engagement protrusion is formed with an open hole, and deformation of the engagement protrusion moves towards the open hole so that the open hole is deformed.

11. The lamp seat structure of claim 1, wherein the engagement protrusion is formed with a dent, and deformation of the engagement protrusion moves towards the dent so that the dent is deformed.
